(19) United States
(12) Patent Application Publication
(10) Pub. No.: US 2012/0044129 A1
(43) Pub. Date: Feb. 23, 2012

(54) REFLECTIVE COLOUR DISPLAY DEVICE

(75) Inventor: John C. Rudin, Bristol (GB)

(73) Assignee: Hewlett-Packard Development Company, L.P., Houston, TX (US)

(21) Appl. No.: 13/266,764

(22) PCT Filed: Apr. 30, 2009
(86) PCT No.: PCT/US09/42237

§ 371 Date: Oct. 27, 2011

(51) Int. Cl. G09G 3/30; B32B 37/14; B32B 38/10; B32B 38/00; G09G 3/20; B05D 5/06

(52) U.S. Cl. 345/76; 345/55; 427/162; 156/247; 156/275.5

(57) ABSTRACT

A reflective colour display device comprises a plurality of capillary sub-pixels arranged side by side. Each capillary sub-pixel has a first end and a second end, and a scattering medium disposed between said ends. Each capillary sub-pixel contains a transparent coloured medium which can be reversibly changed to a medium with a different light absorption property in an optical modulation region between the first end and the scattering medium. The optical modulation region of each capillary sub-pixel has a height to width aspect ratio of at least about 3. Light incident on the scattering medium through a first sub-pixel will be scattered into at least one neighbouring sub-pixel having a coloured medium of different colour to coloured medium in the first sub-pixel.

### CROSS-REFERENCE TO RELATED APPLICATION

The present application is the U.S. National Stage under 35 U.S.C. §371 of International Patent Application No. PCT/US2009/042237, filed 30 Apr. 2009, the disclosure of which is hereby incorporated herein by reference.

### BACKGROUND

The invention relates to a reflective colour display device and a method of manufacture of the device.

Reflective colour display devices rely either on the selective absorption or selective reflection of parts of the visible wavelength spectrum which correspond to the viewer's eye colour stimulation response. Consequently, any incident light must either pass through a number of discrete layers or regions of optical modulation material (for example stacked CYM absorbers or RGB reflectors), pass through a combination of separable absorbers, or must be separated into three colour channels, separately modulated and mixed back together again.

A typical prior art reflective colour display is shown in FIG. 1. The device 1 comprises three or four layers of an electro-optic material 2 sandwiched between a first substrate 3 and a second substrate 4. Examples of electro-optic materials include liquid crystals and electrophoretic mixtures. Each layer 2 has a thickness of about 7-10 μm with a pixel size of 100-200 μm. Electrodes are used to apply an electric field across the electro-optic material to cause a change in an optical property of the material. Light 5 entering the front of the display 1 has to travel through addressing electrode structures on both opposed substrates 3, 4 of each layer 2 before being reflected back through the same six electrode structures again. Any losses in each electrode structure are thereby raised to the power of 12. (e.g. a 2% loss in each layer represents an overall loss of 22%).

Aspects of the present invention are specified in the independent claims. Preferred features are specified in the dependent claims.

We have found that by providing an array of capillary sub-pixels with an intermediate light-scattering medium, and a height to width ratio of at least 3,preferably 5-15, between a viewing end and the scattering medium, a full colour reflective display device with improved properties can be obtained.

Each capillary sub-pixel contains a transparent coloured medium whose absorption in a waveband can be controlled. Typically the medium will be a fluid which can be reversibly changed to a medium with a different light absorption property, preferably to a fluid medium that transmits substantially all visible wavelengths. The transparent coloured medium may be one which can be controlled to change its absorption properties without moving, for example an electrochromic composition or a plasmonic resonance material which changes refractive index or size when suitably energised. In other embodiments, the transparent coloured medium is, or contains particles which are, movable, notably transparent pigment particles. In these embodiments, the medium or the particles are reversibly movable from a viewed region on one side of the scattering medium to a storage region on the other side of the scattering medium. In these embodiments, the scattering medium is porous to permit movement from the viewed region to the storage region.

In a preferred embodiment, the display is an electrophoretic device, and the transparent coloured medium is an electrophoretic composition made up of transparent pigment particles in a carrier fluid. For a full colour display, different capillary sub-pixels will contain one of cyan, yellow and magenta transparent pigment particles and, optionally, black particles. However, it will be understood that the invention is not limited to this embodiment. The pigment particles may be moved by any suitable means known in the art, for example electrophoresis, electro-osmosis, electro-wetting or applied microfluidic pressure or flow. The transparent coloured medium could also be an immiscible fluid which is pumped through the scattering medium. For convenience, the invention will be described with reference to specific embodiments in which the display is an electrophoretic display.

The device is suitable for use in a wide range of display applications and may be scaled up to any desired size, for example millimetre-length capillaries might be used for low resolution signage applications.

### BRIEF DESCRIPTION OF THE DRAWINGS

The invention will now be further described, by way of example only, with reference to the following drawings, in which:

FIG. 1 is a schematic view of a prior art display device having stacked colour modulation layers;

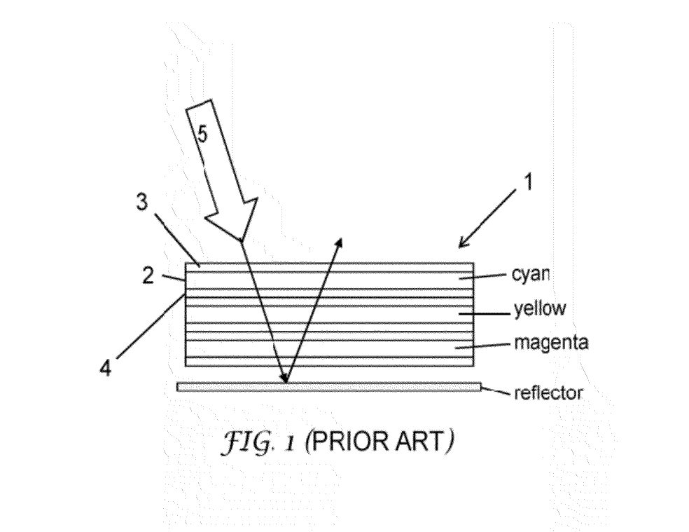

FIG. 2 is a plan view of a display in accordance with an embodiment of the invention, and a pixel of the display at different magnifications showing that each pixel is formed from a large plurality of capillaries;

FIG. 3 is a schematic sectional view through part of the display of FIG. 2;

FIG. 4 is a schematic sectional view through part of a capillary sub-pixel in accordance with another embodiment of the invention;

FIG. 5 is a view corresponding to FIG. 3, illustrating scattering of incoming light;

FIGS. 6A-E are schematic illustrations of the manufacture of a plurality of capillary sub-pixels in accordance with an embodiment of another aspect of the invention;

FIGS. 7A-C are schematic illustrations of a manufacturing step in accordance with a further embodiment of another aspect of the invention;

FIG. 8 is a schematic illustration of a method of filling capillary sub-pixels in accordance with another embodiment of the invention; and

FIG. 9 is an SEM photomicrograph of an experimental set of capillaries in accordance with a further embodiment of the invention.

### DETAILED DESCRIPTION

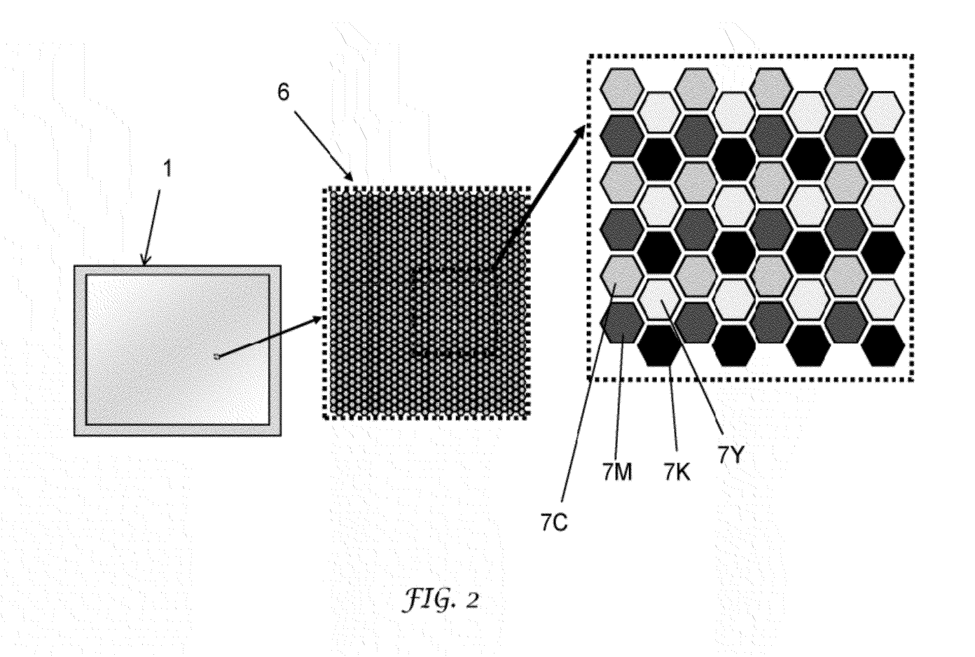

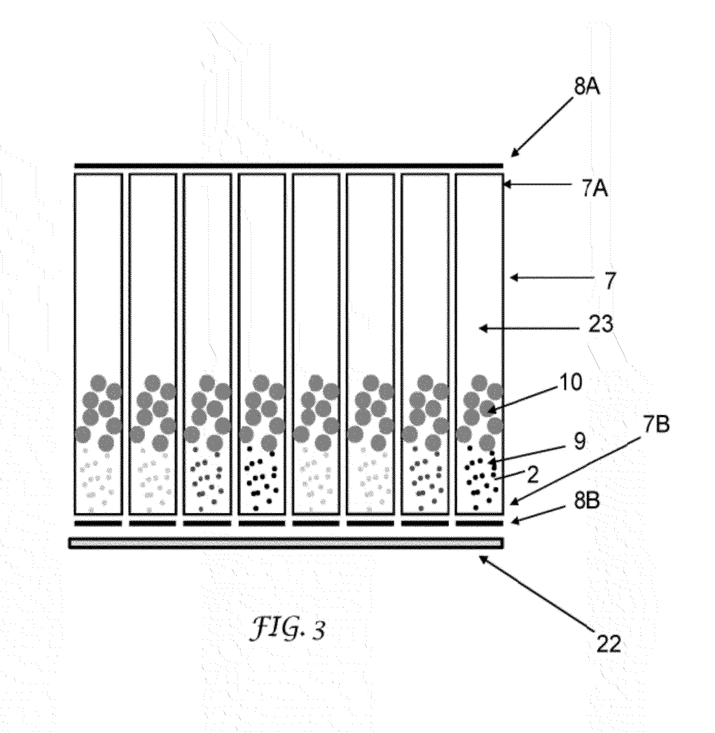

The embodiment of the invention shown in FIGS. 2 and 3 is a reflective colour display device 1 which has an array of pixels 6. Each pixel 6 is made up of a plurality of capillary sub-pixels 7 arranged side by side. Each capillary sub-pixel 7 has a first end 7A with a first electrode 8A and a second end 7B with a second electrode 8B. A porous scattering medium 10, which in this embodiment scatters all wavelengths of visible light, is disposed between the first and second electrodes. Each capillary sub-pixel 7 is filled between the electrodes 8A, 8B, with a transparent, non scattering, coloured medium 2 the absorbance in a particular waveband of which can be electrically controlled, which in this embodiment is an electrophoretic composition 2 which comprises pigment particles 9 in a carrier fluid. Each capillary sub-pixel 7 has a height to width aspect ratio (for the optical modulation region 23 between the first end 7A and the scattering medium 10) of at least about 3, preferably a ratio in the range 5-15, notably about 10. The capillaries 7 preferably have a height in the range 10-50 μm, and a width in the range 2-5 μm, although the display may be scaled up to much greater sizes depending on the specific application.

In this embodiment the sub-pixels 7 are arranged in a hexagonal array of different coloured absorbers. Sub-pixels 7C, 7Y, 7M and 7K contain, respectively, cyan, yellow, magenta and black pigment particles, for modulation of, respectively, red, blue, green and white wavebands of light. It will be understood that the black absorber is not essential for a full colour display. In this embodiment the sub-pixels 7 are in a hexagonal array in the middle of which each of the four colours of absorber is surrounded by two each of the other three colours, as best illustrated in the smallest scale representation in FIG. 2. The cyan, yellow and magenta pigment particles 9 are transparent, so that wavelengths of light which are not absorbed are substantially transmitted and not scattered. The black pigment particles 9K, of course, absorb substantially all incident visible light. Typically, each pixel 6 is made up of many hundreds or thousands of capillary sub-pixels 7.

The display device 1 may optionally use a porous scattering medium 10 which is fluorescent (white light-emitting), which may be pumped by a UV backlight 22, as illustrated in FIG. 2, provided that the pigment particles and carrier fluid do not substantially absorb the UV light. By this means the display may operate in low ambient light.

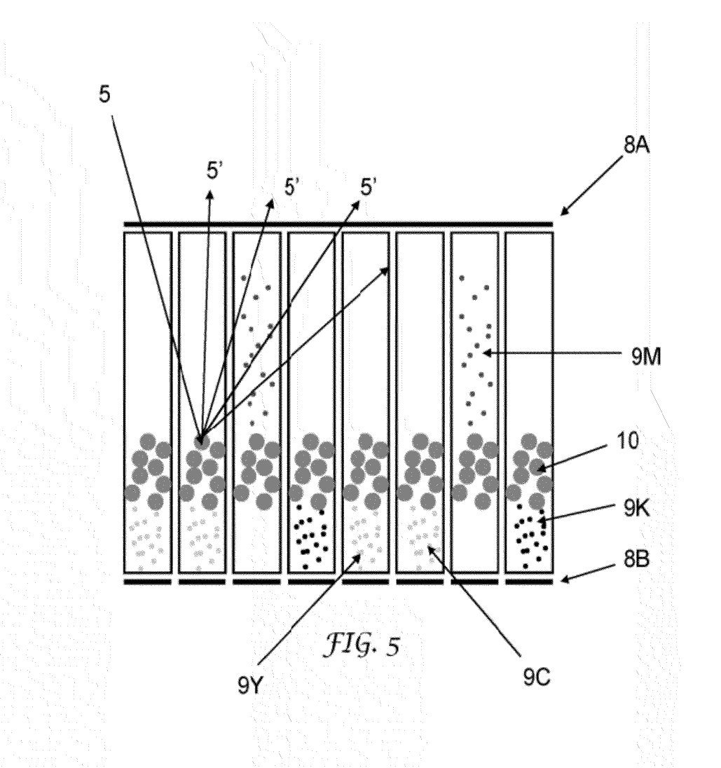

As illustrated in FIG. 5, the relatively high aspect ratio of the capillary sub-pixels 7 provides that light 5 incident on the porous scattering medium 10 through a first sub-pixel will be scattered 5′ into at least one neighbouring sub-pixel having pigment particles of different colour to pigment particles in the first sub-pixel. In a preferred embodiment, scattered light 5′ passes through a plurality of neighbouring sub-pixels. The high aspect ratio of the capillary sub-pixels 7 also ensures that incident light at most angles will pass through a number of capillary sub-pixels before reaching the porous scattering medium 10. By providing for multiple-absorptions of incident light, the optical efficiency of the display 1 may be improved over prior art displays. Having only a single layer of electro-optic material 2 means that unwanted absorptions from substrates and electrodes are minimised or reduced. The white scattering medium 10 provides an appearance similar to paper, making the device particularly useful for applications such as e-paper, both for large scale applications such as electronic billboards and small scale applications such as displays for mobile phones (cell phones).

In the illustrated embodiments, the first electrode 8A provides a common electrode and the second electrodes 8B are addressing electrodes for each sub-pixel 7. The sub-pixels 7 may be in a simple repeating CYM or CYMK array with interleaved busbar electrodes between the capillaries effectively underneath the capillary walls. In one embodiment the capillary sub-pixels 7 may be integrated directly onto an active matrix backplane to provide the addressing electrodes 8B.

In operation, the electrodes 8 are used to provide field and/or charge injection to cause the selective electrophoresis of the coloured (CMYK) particles 9 through the porous scattering medium 10 from the bottom part of the capillaries (below the scattering medium 10) into the viewed (top) part of the capillaries. When white light 5 enters the display it will pass through one or more of the capillaries 7 and its spectrum will be modified by the pigment particles 9. The intermediate scattering medium 10 will reflect and scatter the light such that even light normal to the display will pass through a number of capillaries 7 before exiting. The full colour gamut can thus be obtained, and in particular a good white reflecting state. In the example illustrated in FIG. 5, magenta sub-pixels are activated to cause migration of magenta pigment particles 9M from below the porous scattering medium 10 to the viewed (top) part of their capillaries 7. Incident light 5 passes through several capillaries both before and after being scattered by the scattering medium 10, and green wavelengths are absorbed by the magenta particles 9M. If particles of another colour were also selectively transferred to the viewed part, a different colour would be displayed by the pixel 6. For example, if yellow particles 9Y are transferred to the viewed part of their capillaries 7, the pixel would absorb both blue light and green light and would appear red in reflection.

The pigment particles 9 are preferably nanoparticle sized (<100 nm, notably 10-40 nm) and are suspended in the carrier fluid. Ideally the pigment particles are below the optical scattering limit, and small enough to pass unhindered through the porous scatterer 10. The particles 9 may be treated to remain suspended by Brownian motion/thermal action only, and substantially unmoved by gravity. Suitable methods of preventing agglomeration of nanoparticle-sized pigments will be well known to those skilled in the art. The electrophoretic host material may be isotropic (for example Isopar M) or anisotropic (for example a liquid crystal). Suitable particles and host materials will be well known to those skilled in the art of electrophoretic display device manufacture. The electrophoretic effect itself has limited threshold and inherent memory. However, the electrophoretic effect may be provided with a suitable threshold for passive matrix addressing by dispersing the pigment particles in a suitable liquid crystal host, for example as described in U.S. Pat. No. 7,362,406, the contents and disclosure of which are incorporated herein by reference in their entirety. Passive matrix addressing will further reduce the complexity of the display device.

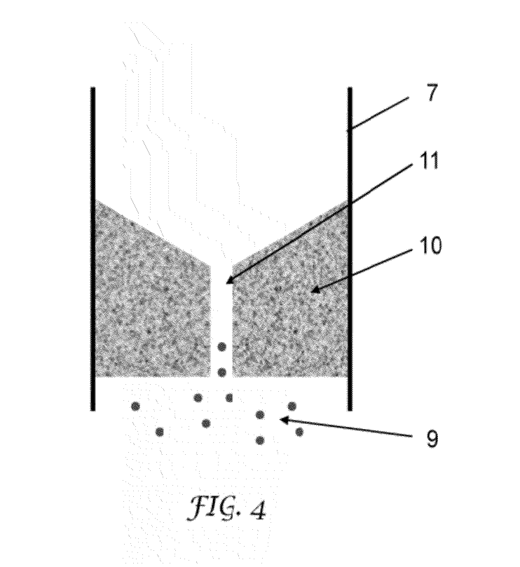

The porous scattering medium 10 may be provided by a layer of scattering particles of suitable size, for example large (˜3 μm) mono-size dispersed coated silica beads, adhesively coated to provide a porous matrix. Alternatively, as illustrated in FIG. 4, a solid scattering layer 10, preferably white, may be fabricated with one or more venting openings 11. The backscattering angle of the layer 10 can be optimised to prevent scattering at high angles which would not escape the front surface of the display resulting in loss of reflected power. In the embodiment of FIG. 4, a central vent opening 11 is provided in the white scattering layer 10. The opening 11 is of much greater dimensions than the pigment nanoparticles 9, which can readily pass through under the influence of a suitable applied electric field, or hydrodynamic flow.

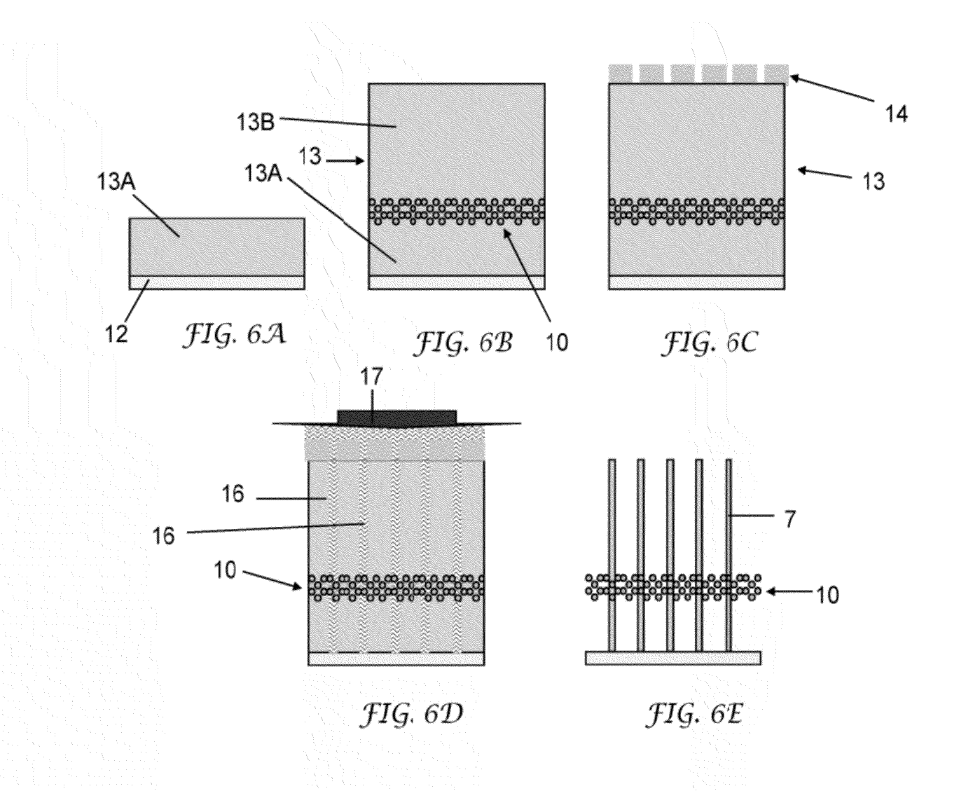

A method of manufacturing a plurality of sub-pixels side by side for use in fabricating a display device in accordance with an aspect of the invention is illustrated in FIG. 6. A blank 13 of a UV- or x-ray photocurable resin material is provided on a support substrate 12. In this embodiment, a blank 13 of an SU8 x-ray sensitive material is formed by providing a first resin layer 13A on the support 12 (FIG. 6A), after which a second layer 13B of resin is coated on top of the first layer 13A, with a layer of scattering particles 10 embedded therein. (FIG. 6B). A metallic mask 14, is laminated on the blank 13 (FIG. 6C) and the blank 13 is illuminated by x-rays 17 through the mask 14 (FIG. 6D). The mask 14 is patterned to correspond to walls that will define the capillaries 7. Regions 16 of the resin 13 not corresponding to regions of metal in the mask 14 are irradiated, while the remaining regions of the resin 13 are substantially not irradiated. The scattering layer 10 will scatter visible light, but substantially does not scatter x-rays. In this example the resin is photocuring (negative tone), and after removal of the mask 14 and rinsing out of uncured material, a plurality of capillaries 7 remain, with an intermediate layer of scattering medium 10 (FIG. 6E). The capillaries 7 may then be filled with suitable electrophoretic media 2. The support substrate 12 may optionally function as one of the electrodes 8.

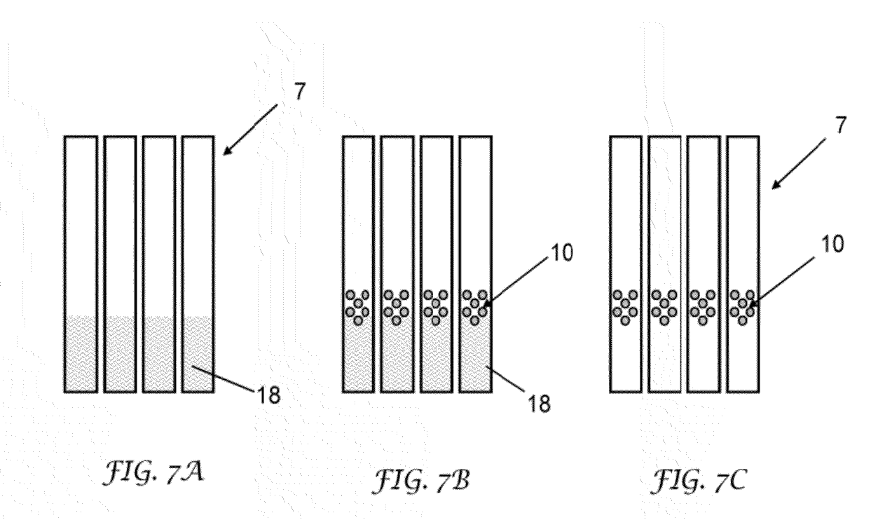

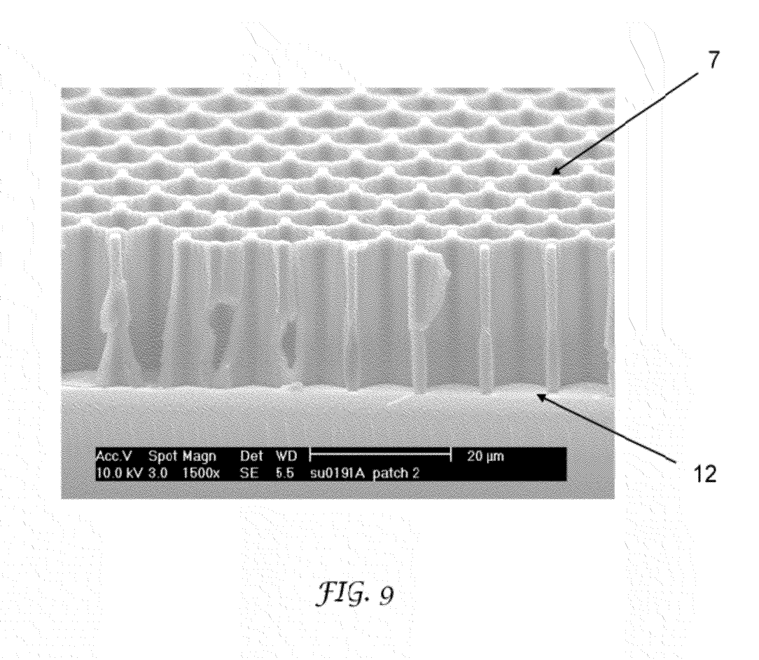

In another variation, the blank resin 13 is formed as a single layer without the embedded scattering material 10, so that the process of FIG. 6 produces the array of capillaries 7 without the scattering layer 10. In this case UV irradiation can be used to photopattern the curable resin. An experimental example of such an array of capillaries 7 is shown in FIG. 9. In this example, the resist was a photocurable epoxy resin (SU8-2000, Microchem Corp) which was formed on the support substrate 12 and exposed to UV-radiation through a 0.5 μm chromium mask. The scattering layer 10 may be provided by partially filling the capillaries 7 with a buoyancy fluid 18 to the point where the layer 10 is desired (FIG. 7A), and introducing particles of scattering medium 10 which float at or on the surface of the buoyancy fluid 18 (FIG. 7B). The particles 10 are treated to cause them to adhere to each other and to the walls defining the capillary 7. This may be done by any suitable means, for example: by pre-coating the particles with an adhesive, or by the buoyancy fluid causing the particles 10 to become tacky, or by other means such as heating the particles when in the capillaries 7 to induce tack. After the particles 10 have become adhered to each other and to the capillary walls, the buoyancy fluid 18 is drained out to leave the array of capillaries 7 with the intermediate layer 10 of porous light-scattering medium. The buoyancy fluid 18 may optionally be the carrier fluid 21. In this embodiment, the step of removing the buoyancy fluid may be omitted.

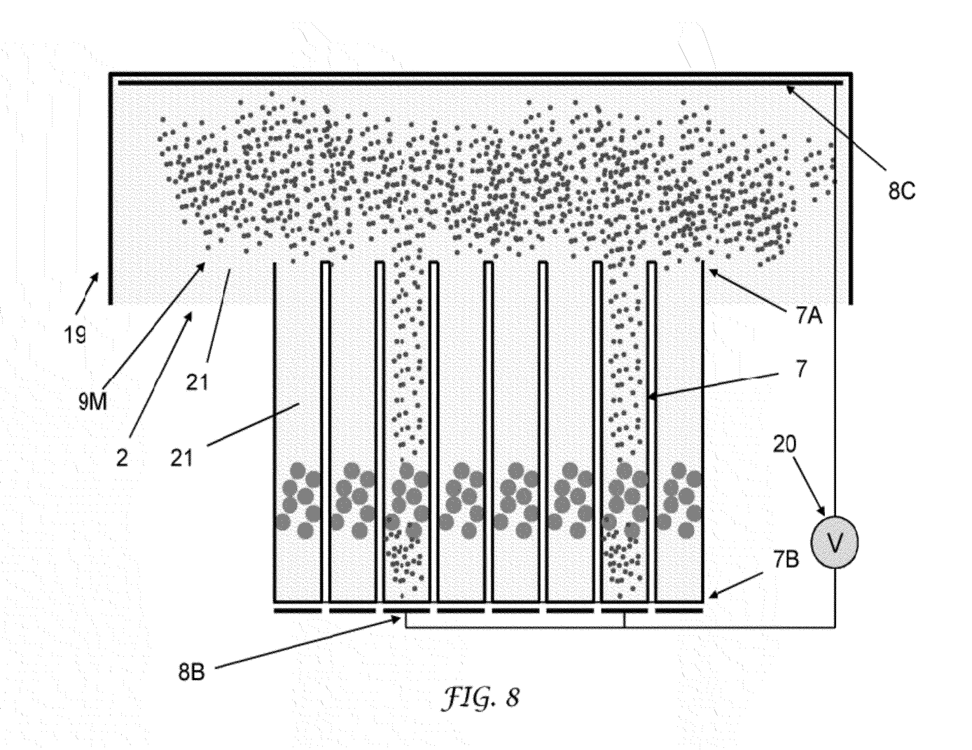

Turning now to FIG. 8, a method of selectively filling the capillaries 7 is illustrated. The array of capillaries 7 is formed on or transferred to a substrate patterned with the addressing electrodes 8B and filled with carrier fluid 21 of the electrophoretic composition 2. The first ends 7A of the capillaries are open and immersed in a reservoir 19 containing one of the electrophoretic compositions 2. In this example the electrophoretic composition 2 contains magenta pigment particles 9M. A counter electrode 8C is provided in the reservoir 19. To fill selected capillaries 7 with magenta-containing electrophoretic composition 2, a suitable voltage is applied across the electrodes 8B corresponding to the magenta capillary sub-pixels 7 and the counter electrode 8C via a power source 20. The magnitude and polarity of the applied voltage is such as to cause electrophoretic migration of particles 9M from the reservoir into the selected capillaries 7. Once a desired amount of migration has taken place (for example measured by elapsed time or by amount of charge passed) the reservoir 19 is removed and replaced with a reservoir 19 containing a different electrophoretic composition 2 having a different colour of pigment, for example yellow, cyan or black. The process is repeated until all capillaries have received the desired pigment particles. The array of capillaries 7 is then removed from the reservoir 19 and provided with a single electrode 8A, optionally after being sealed with a thin capping layer, for example a curable capping layer.

The capillaries 7 may be formed from any suitable material which is substantially insoluble in the carrier fluid 21. However, for better optical performance, it is preferred that the material is optically clear, and index-matched to the refractive index of the carrier fluid 21 to minimise losses and scattering from the walls. Whilst in this illustration the capillaries are shown as hexagonally close packed tubes with hexagonal internal cross sections, it is understood that other internal cross sections and packing formations, including randomised packing are possible, with the inter-capillary spaces filled with a suitable index matched material.

The articles ‘a’ and ‘an’ are used herein to denote ‘at least one’ unless the context otherwise requires.

1. A reflective colour display device comprising a plurality of capillary sub-pixels arranged side by side; each capillary sub-pixel having a first end and a second end, and a scattering medium disposed between said ends, each capillary sub-pixel containing a transparent coloured medium which can be reversibly changed to a medium with a different light absorption property in an optical modulation region between the first end and the scattering medium; wherein the optical modulation region of each capillary sub-pixel has a height to width aspect ratio of at least about 3, and wherein light incident on the scattering medium through a first sub-pixel will be scattered into at least one neighbouring sub-pixel having a coloured medium of different colour to coloured medium in the first sub-pixel.

2. device according to claim 1, wherein in the absence of coloured medium in the optical modulation region of a first capillary sub-pixel, at least 50% of incident light normal to the first end of the first sub-pixel will be scattered into at least one neighbouring capillary sub-pixel.

3. A device according to claim 1, wherein light incident on the scattering medium through a first sub-pixel will be scattered into a plurality of neighbouring sub-pixels.

4. A device according to claim 1, wherein the transparent coloured medium is made up of transparent pigment particles in a carrier fluid, the particles being movable by at least one of electrophoresis, electro-osmosis, or applied pressure, and wherein the scattering medium is porous to permit movement of the particles from the optical modulation region to a storage region between the scattering medium and the second end of the capillary.

5. A device according to claim 1, wherein the scattering medium is porous and the transparent coloured medium is a fluid which is movable by pumping through the porous scattering medium.

6. A device according to claim 1, wherein the transparent coloured medium is an electrochromic composition.

7. A device according to claim 1, wherein the aspect ratio of the optical modulation region of the capillary sub-pixels is in the range 5 to 15, preferably about 10.

8. A device according to claim 1, wherein the scattering medium is fluorescent, and wherein the device further comprises an ultraviolet backlight arranged to irradiate the scattering medium.

9. A device according to claim 1, further comprising a first electrode at the first end of each capillary sub-pixel and a second electrode at the second end of each sub-pixel for energising the transparent coloured medium.

10. A device according to claim 1, wherein the capillary sub-pixels are arranged in an array of cyan, yellow and magenta sub-pixels each of which contains transparent coloured medium, and optionally further capillary sub-pixels which contain a black medium.

11. A method of manufacturing a reflective colour display device in accordance with claim 1, the method comprising:
forming a plurality of capillaries side by side, each capillary having a first end, a second end, a scattering medium disposed between said ends, and an optical modulation region between the first end and the scattering medium; the optical modulation region of the capillaries having a height to width aspect ratio of at least about 3; and
filling at least some of each capillary with a transparent coloured medium which can be reversibly changed to a medium with a different light absorption property in the optical modulation region; and
wherein light incident on the porous scattering medium through a first capillary will be scattered into at least one neighbouring capillary having a coloured medium of different colour to coloured medium in the first capillary.

12. A method according to claim 11, wherein the step of forming the capillaries comprises:
a) taking a blank of a photocurable material;
b) laminating a metal mask to said blank, regions of metal in the mask corresponding to either the desired internal shape of the capillaries or the desired shape of walls to define the capillaries;
c) exposing the blank to electromagnetic radiation to which the photocurable material is sensitive so as to irradiate regions of the photocurable material not corresponding to regions of metal in the mask and substantially not to irradiate regions of the photocurable material corresponding to regions of metal in the mask; and
d) developing to selectively remove those portions of the photocurable material exposed to the radiation if the photocurable material has a positive tone; or to selectively remove the unexposed portions of the photocurable material if it has a negative tone, thereby forming a plurality of capillary sub-pixels arranged side by side and having a height to width aspect ratio of at least about 3.

13. A method according to claim 12, wherein the blank contains a layer of a scattering material so that each capillary is formed with a layer of the scattering material intermediate each end; the scattering material being substantially scattering in the visible light spectrum, but substantially not scattering in the waveband region of the radiation used to irradiate the photocurable material.

14. A method according to claim 13, further comprising forming the blank by:
forming a first layer of the photocurable material; and
forming a second layer of photocurable material on said first layer, with a layer of a scattering material embedded therein.

15. A method according to claim 12, further comprising:
partly filling each capillary with a buoyancy fluid and a plurality of light-scattering particles which float at or on the surface of said buoyancy fluid;
treating the particles in each capillary to cause them to adhere to each other and to the walls defining the capillary; and optionally removing the buoyancy fluid.
